(19) United States
(12) Patent Application Publication
(10) Pub. No.: US 2005/0157295 A1
(43) Pub. Date: Jul. 21, 2005

(54) Ellipsometry system and method using spectral imaging

(75) Inventors: Won Chegal, Daejon (KR); Hyun Mo Cho, Daejon (KR); Yong Jai Cho, Daejon (KR); Yun Woo Lee, Daejon (KR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: KOREA RESEARCH INSTITUTE OF STANDARDS AND SCIENCE, Daejon (KR)

(21) Appl. No.: 10/927,929

(22) Filed: Aug. 27, 2004

(30) Foreign Application Priority Data
Jan. 15, 2004 (KR) 10-2004-0002880

(51) Int. Cl. G01J 4/00

(52) U.S. Cl. 356/369

(57) ABSTRACT

An ellipsometry system and method using spectral imaging are provided. The ellipsometry system includes a light source group for projecting a white light collimated to a multi-point region defined on the surface of a sample, a light analysis group for polarizing a reflected white light to analyze it, and a spectral imaging group for dispersing and imaging the polarized white light. The white light collimated to the multi-point region is input to the spectral imaging group and dispersed by a light dispersing means by wavelengths such that the dispersed lights are imaged on one axis of an imaging plane by the points forming the multi-point region and imaged on the other axis of the imaging plane by wavelengths, to obtain optical data having information about the physical property of the points and wavelengths. Accordingly, a large amount of data can be obtained by wavelengths and points to improve rapidity and reliability of measurement.

### FIELD OF THE INVENTION

The present invention relates to an ellipsometry system and method for obtaining information about the physical property of a sample based on the measurement of a variation in polarized state. Specifically, the present invention relates to an ellipsometry system and method using spectral imaging, which uses a white light collimated to a multi-point region defined on a sample as a measurement light and spectral-images the measurement light to obtain information about the physical property of each of points forming the multi-point region by wavelengths at a time, to thereby acquire a large amount of optical data.

### BACKGROUND OF THE INVENTION

It is known that the polarized state of a light that is input to a specific object and reflected from the object or transmitted through the object is based on the property and structure of the object. To measure characteristics (for example, surface structure, film structure and so on) of an object using polarization characteristic of light is called a polarization optical measurement technique.

It is known that, when a linearly polarized light is input to a sample, it is changed to an elliptically polarized light. To obtain data about the property and surface structure of the sample from the elliptically polarized light is called ellipsometry.

In a semiconductor or optical material field and its processing field, an in-situ measurement technique that measures a sample in situ without decomposing the sample or separating the sample from a manufacturing equipment is increasingly needed in order to improve reliability in measurement. The aforementioned optical measurement technique can cope with the in-situ measurement. The ellipsometry is frequently used for thin film analysis such as the measurement of the thickness and density distribution of an oxide film.

The ellipsometry can measure a sample when only an environment where a light transmits the sample is prepared even if the sample is placed in the air, vacuum, plasma, acid or basic solution. Furthermore, the ellipsometry can carry out measurement even in a very high-temperature or very low-temperature environment.

Furthermore, it is known that the ellipsometry has high capability of analyzing the surface state of a sample and the structure of a thin film. For example, the ellipsometry can detect a variation of 2 to 3 Å in the surface of a monolayer because a phase change generated when a measurement light is reflected from the sample is very sensitive to a variation in the surface of the sample.

Accordingly, the ellipsometry has an advantage of consecutively obtaining data in observation of processes such as deposition, etching, heat treatment and surface reaction in semiconductor processes.

The ellipsometry is carried out by an ellipsometer. The ellipsometer measures a measurement angle with respect to a wavelength, which is represented by ψ and Δ. Especially, an ellipsometry angle is important data that represents information about the physical property of a sample. In a prior art, when a light path is divided into an incident light path and a reflected light path, a spectroscope is located on the incident light path or the reflected light path and a sample is optical-scanned while being transferred by a separate transfer device. Configurations in which the spectroscope is located on the incident light path and the reflected light path are respectively shown in FIGS. 1 and 2. Referring to FIG. 1, a conventional ellipsometer includes a light source 101, a spectroscope 20 and a polarizer 30, which are arranged on the incident light path, and an analyzer 40 and a light detector 50, which are arranged on the reflected light path.

When a light (represented by arrows) is emitted from the light source 10, the light passes through the spectroscope 20 and the polarizer 30 and then input to a sample 60. Here, the light emitted from the light source 10 is a white light including all wavelengths. The spectroscope 20 filters the white light to obtain a light having a single wavelength. The polarizer 30 changes the polarized state of the light into a specific state, for example, a linearly polarized state. Accordingly, if the light having a specific wavelength is blue light, the blue light in the linearly polarized state is input to the sample 60 and reflected from the surface of the sample.

The linearly polarized blue light is reflected from the surface of the sample 60 to be changed into an elliptically polarized blue light, and then input to the analyzer 40 located on the reflected light path. The light detector 50 senses the elliptically polarized blue light to obtain data about the property or structure of the surface of the sample 60. Accordingly, an ellipsometry angle is calculated from the polarized state of the reflected light. The ellipsometry angle can be obtained by attaining final polarization data and mathematically arranging the ratio of the amplitude of the reflected light to the amplitude of the incident light and a phase difference between the incident light and reflected light based on the final polarization data.

The ellipsometer shown in FIG. 2 has the spectroscope 20 located on the reflected light path. The ellipsometer includes the light source 10, polarizer 30, which are arranged on the incident light path, and the analyzer 40, spectroscope 20 and light detector 50, which are arranged on the reflected light path.

In this ellipsometer structure, the white light emitted from the light source 10 passes through the polarizer 30 to be changed into a linearly polarized light. The linearly polarized light is input to the sample 60 and reflected from the surface of the sample to be changed into an elliptically polarized light. The elliptically polarized light passes through the analyzer 40 to become a linearly polarized light again. The linearly polarized light is input to the spectroscope 20 and filtered such that the light detector 50 senses only a light having a predetermined wavelength.

In addition, the ellipsometry angle can be obtained through a predetermined mathematical calculation based on the polarized state of the light after the light has been reflected.

If a user wants to know the property or structure of a specific position indicated by one point on the surface of the sample 60, the measurement process of the conventional ellipsometer inputs lights with various wavelengths to the corresponding point and reflects the lights to obtain a large amount of data.

If the user wants to know the entire structure of the surface of the sample 60, the ellipsometer carries out multi-point measurement while changing the position of the sample using a separate transfer device. That is, the ellipsometer performs processes of inputting a light with a single wavelength to the overall surface of the sample 60 and reflects the light.

When the conventional ellipsometer performs the aforementioned measurement processes, 0.1 to 1 second is required to input the light to the sample and reflect the light from the sample to obtain data once. Accordingly, if the ellipsometer carries out measurement for a single point using 1000 lights with different wavelengths or measurement for 1000 multiple points using a light with a single wavelength, approximately 100 to 1000 seconds are required. Consequently, rapid measurement cannot be secured. A long period of measurement time may make the sample 60 be deteriorated or contaminated by particles. Furthermore, the light emitted from the light source 10 is not stable so that reliability of the data obtained after the measurement is reduced.

### SUMMARY OF THE INVENTION

Accordingly, the present invention has been made in view of the above problems occurring in the prior art, and it is an object of the present invention is to provide an ellipsometry system and method using spectral imaging for obtaining information about the physical property of each of points forming a multi-point region at a time by using a white light collimated to the multi-point region as a measurement light.

Another object of the present invention is to provide an ellipsometry system and method using spectral imaging, which disperses a white light collimated to a multi-point region by wavelengths and images the dispersed lights to obtain a plurality of information items about a single point through the dispersed lights, thereby acquiring a large amount of optical data.

To accomplish the objects of the present invention, there is provided an ellipsometer system using spectral imaging, comprising: a light source group including a light source module for collimating/projecting a white light to a multi-point region located in one direction on the surface of a sample, and a polarizer located on a path of the projected light to linearly polarize the white light; a light analysis group including a analyzer, arranged optically opposite to the light source group, for linearly polarizing the white light that is reflected from the multi-point region of the sample and elliptically polarized and has information about position and physical property of the multi-point region; a spectral imaging group located on the same optical axis as that of the light analysis group, the spectral imaging group including light dispersing means for dispersing the white light by wavelengths, and light detection means for simultaneously imaging the dispersed lights on an imaging plane in the directions of axes of the imaging plane based on the wavelengths of the dispersed lights and respective points forming the multi-point region; and a computer electrically connected to the light detection means for calculating an ellipsometry angle of each of the lights, which corresponds to the wavelength of the light and each of the points forming the multi-point region, based on data transmitted from the light detection means.

Preferably, the light source group further includes a first phase retarder that is located behind the polarizer on the same optical axis as that of the polarizer and circularly or elliptically polarizes the linearly polarized white light.

Preferably, the light analysis group further includes a second phase retarder located in front of the analyzer on the same optical axis as that of the analyzer to polarize the elliptically polarized white light, the second phase retarder optically corresponding to the first phase retarder.

Preferably, the light detection means is a CCD solid-state imaging device.

Preferably, the spectral imaging group further includes a condensing lens located between the light dispersing means and the CCD solid-state imaging device for condensing the dispersed lights on the imaging plane of the CCD solid-state imaging device.

Preferably, the spectral imaging group further includes an entrance slit located in front of the light dispersing means on the same optical axis as that of the light dispersing means to optically align the collimated state of the white light, the shape of the entrance slit corresponding to the initial collimated shape of the white light.

To accomplish the objects of the present invention, there is also provided an ellipsometry method using spectral imaging, including the steps of: projecting a white light collimated to a multi-point region located in one direction on the surface of a sample; linearly polarizing the white light; linearly polarizing a white light reflected from the multi-point region of the sample and elliptically polarized, the white light having information about the position and physical property of the multi-point region; optically aligning the collimated state of the white light; dispersing the aligned white light by wavelengths; simultaneously imaging the dispersed lights on an imaging plane along the directions of axes of the imaging plane based on corresponding wavelengths of the lights and points forming the multi-point region; and calculating an ellipsometry angle of each of the lights, which corresponds to the wavelength of the light and each of the points forming the multi-point region, based on data obtained from the imaged lights.

Preferably, the ellipsometry method further comprises a step of circularly or elliptically polarizing the linearly polarized white light through phase retardation after the step S2000 of linearly polarizing the white light.

Preferably, the ellipsometry method further comprises a step of polarizing the white light such that the polarized state of the white light optically corresponds to the polarized state before the white light is reflected, before the step S3000 of linearly polarizing the reflected white light.

Preferably, in the step of imaging the dispersed lights, the dispersed lights are imaged on a CCD solid-state imaging device arranged on the optical paths of the dispersed lights.

Preferably, the ellipsometry method further comprises a step of condensing the dispersed lights on the imaging plane of the CCD solid-state imaging device after the step S5000 of dispersing the white light.

Preferably, in the condensing step, the dispersed lights are condensed by a condensing lens that is arranged in front of the CCD solid-state imaging device on the optical paths of the dispersed lights.

Preferably, in the step of aligning the collimated sate of the white light, the collimated state of the white light is aligned using an entrance slit whose shape corresponds to the initial collimated shape of the white light.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a configuration of a conventional ellipsometer;

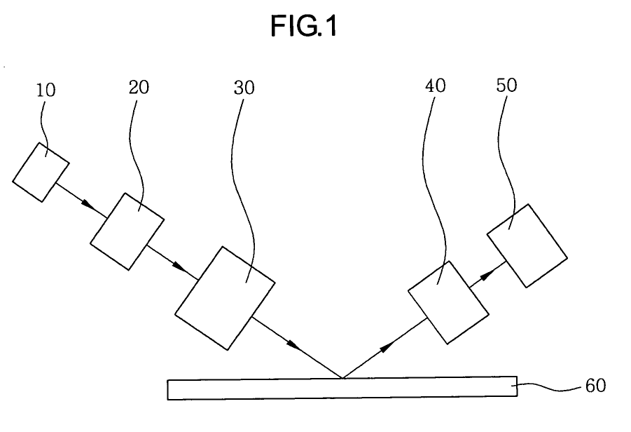

FIG. 2 illustrates another configuration of the conventional ellipsometer;

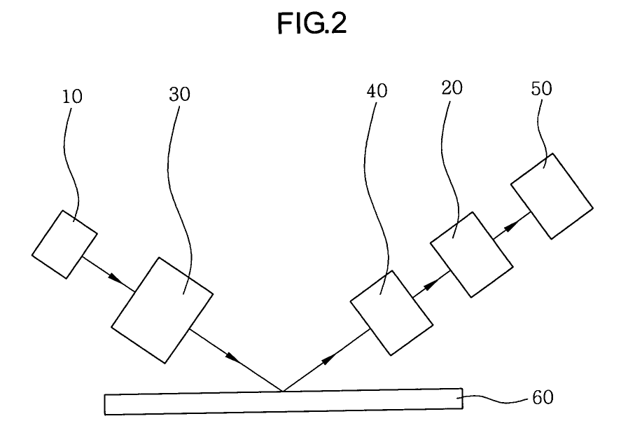

FIG. 3 illustrates a configuration of an ellipsometer using spectral imaging according to the present invention;

FIG. 4 illustrates a configuration of the spectral imaging group shown in FIG. 3; and

FIG. 5 is a flow chart showing an ellipsometry method using spectral imaging.

### DETAILED DESCRIPTION OF THE PREFERRED EMBODIMENTS

Reference will now be made in detail to the preferred embodiments of the present invention, examples of which are illustrated in the accompanying drawings.

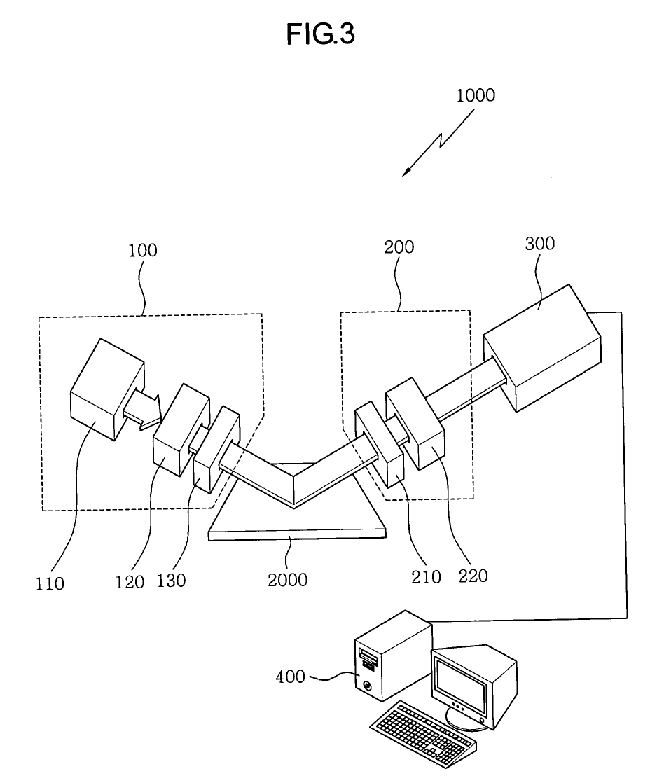

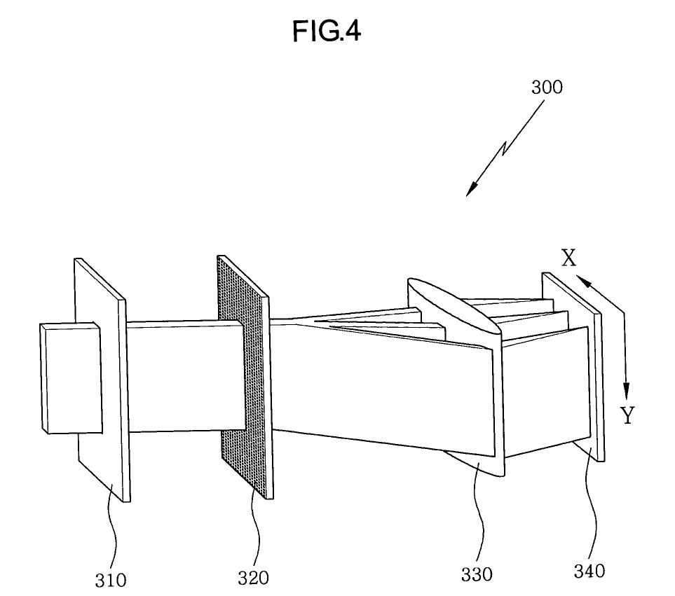

FIG. 3 illustrates a configuration of an ellipsometer using spectral imaging according to the present invention, and FIG. 4 illustrates a configuration of the spectral imaging group shown in FIG. 3. Referring to FIGS. 3 and 4, the ellipsometer 1000 according to the present invention collimates and projects a white light (indicated by a plate-shape arrow) to a multi-point region of a sample 2000 and reflects the light to obtain a white light having information about the physical property of the multi-point region, disperses the white light by wavelengths and images the dispersed lights based on wavelengths and points forming the multi-point region, to thereby simultaneously obtain information about the wavelengths of the dispersed lights and ellipsometry angle information of the lights with respect to the points of the multi-point region.

The ellipsometer 1000 according to the present invention includes a light source group 100 and a light analysis group 200, which are respectively arranged on a white light incident path and a reflection path, optically opposite to each other, having the multi-point region of the sample 200 placed between them. The ellipsometer 1000 further includes a spectral imaging group 300 located on the same optical axis as that of the light analysis group 200.

The light source group 100 includes a light source module 110 that collimates the white light to the multi-point region of the sample 200 and projects the white light to the multi-point region. A collimating structure of the light source module 110 for collimating the white light is integrally formed with a light source. The multi-point region is an object region to be measured, which is composed of points located in a row on the surface of the sample 2000. The light source module 110 projects the white light that is linearly collimated in a shape corresponding to the multi-point region. Accordingly, when the collimated white light is input to the multi-point region and reflected therefrom, a white light including information about the physical property of the points of the multi-point region can be obtained.

The light incident on the sample 2000 must be linearly polarized in ellipsometry. Thus, the light source group 100 includes a polarizer 120 located on the same optical axis as that of the light source module 110 such that the white light emitted from the light source module 110 is input to the polarizer. Accordingly, the white light is linearly polarized by the polarizer 120.

The ellipsometer 1000 according to the present invention further includes a first phase retarder 130 located on the same optical axis as that of the polarizer 120 behind the polarizer. The first phase retarder 130 changes the phase of light to make the light have a specific polarized state. Since it is known that a specific polarized light functions as a measurement light having higher effectiveness depending on the kind of the sample 2000, the first phase retarder 130 is included in the light source group 100 in order to circularly or elliptically polarize the white light linearly polarized by the polarizer 120.

Since the light source group 100 includes the collimating and polarizing structures, when the white light circularly or elliptically polarized by the first phase retarder 130 is reflected from the multi-point region of the sample 2000, a white light having position information and information about the physical property of each of the points forming the multi-point region can be simultaneously obtained.

The light analysis group 200 is located on the reflection path of the white light reflected from the multi-point region of the sample 2000. The light analysis group 200 receives the white light including the information about the position and physical property of each of the points forming the multi-point region. To optically analyze the physical property information and position information of the white light, the light analysis group 200 optically corresponds to the light source group 100 to polarize the white light. For this, the light analysis group 200 includes an analyzer 220 for linearly polarizing the white light, and a second phase retarder 210 located on the reflection path in front of the analyzer 220. Accordingly, the second phase retarder 210 and the analyzer 220 of the light analysis group 200 optically correspond to the first phase retarder 130 and the polarizer 120 of the light source group 100. The white light reflected from the multi-point region is polarized by the second phase retarder 210 and then linearly polarized by the analyzer 220.

The spectral imaging group 300 aligns, disperses and images the linearly polarized white light. For this, the spectral imaging group 300 includes an entrance slit 310, a light dispersing means 320, and a light detector, which are arranged on the same optical axis, as shown in FIG. 4.

The entrance slit 310 has a shape corresponding to the initial collimated shape of the white light. The white light reflected from the multi-point region is difficult to maintain its initial collimated shape. Thus, the entrance slit 310 located on the reflection path aligns the white light in its initial collimated shape. The entrance slit 310 stands in the spectral imaging group 300.

The light dispersing means 320 is located behind the entrance slit 310 and disperses the white light by wavelengths. The white light aligned by the standing entrance slit 310 has a linear shape in the height direction and the linear shape is continued along the optical path such that the white light has the form of a plate standing in the height direction. This plate-shape white light is dispersed by wavelengths by the light dispersing means 320 located behind the entrance slit 310. That is, the white light is split in the direction of the width of the light dispersing means 320, as shown in FIG. 4.

Since the white light is dispersed by the light dispersing means 320, lights with various wavelengths having the information about the physical property of the multi-point region can be obtained and thus a large amount of optical data by wavelengths can be simultaneously acquired.

The spectral imaging group 300 includes a condensing lens 330 for condensing the lights dispersed by wavelengths on an imaging plane of the light detector. The condensing lens 330 is located on the optical axis between the light dispersing means 320 and the light detector. The condensing lens 330 has a cylindrical lens shape such that the light dispersing means 320 and the light detector are symmetrical. That is, the lights dispersed by the light dispersing means 320 are optically diffused, and then transmit the condensing lens 330 to be condensed on the imaging plane of the light detector.

A CCD solid-state imaging device 340 is used as the light detector in this embodiment. The position of the condensing lens 330 is decided depending on the focusing range of the condensing lens 330 with respect to the area of the imaging plane of the CCD solid-state imaging device 340. Specifically, the condensing lens 330 is located in proximity to the solid-state imaging device 340 when the solid-state imaging device 340 has a small imaging plane and placed distant from the solid-state imaging device 340 when the solid-state imaging device has a large imaging plane.

Since the CCD solid-state imaging device 340 is used as the light detector, digital optical data can be directly obtained without using a separate coding structure.

The lights dispersed in the width direction of the light dispersing means 320, that is, the width direction (X-axis direction) of the imaging plane, are imaged on the imaging plane of the solid-state imaging device 340. Simultaneously, lights reflected corresponding to the points forming the multi-point region in the height direction (Y-axis direction) of the imaging plane are imaged on the imaging plane of the solid-state imaging device 340.

The solid-state imaging device 340 is electrically connected to an analysis computer 400 to transmit obtained optical data to the analysis computer 400. A predetermined analysis program capable of directly calculating ellipsometry angles is installed in the computer 400. Thus, the ellipsometry angles can be immediately calculated based on the optical data.

Furthermore, a plurality of ellipsometry angle values with respect to a specific point of the multi-point region can be obtained from the lights dispersed by wavelengths. Thus, reliable property data of the specific point can be acquired by averaging the ellipsometry angle values.

As described above, the ellipsometer 1000 according to the preset invention includes the light source group 100 for collimating the white light to the multi-point region in accordance with the position and shape of the multi-point region, and the spectral imaging group 300 for dispersing the reflected white light having position information and shape information of each of the points forming the multi-point region by wavelengths. Thus, the dispersed lights are simultaneously imaged on the imaging plane by wavelength and by the points along the X- and Y-axes of the imaging plane. Consequently, items of information about the physical property of respective points forming the multi-point region can be simultaneously obtained. Furthermore, a large amount of optical data about the multi-point region can be secured using the structure of dispersing the light by wavelengths.

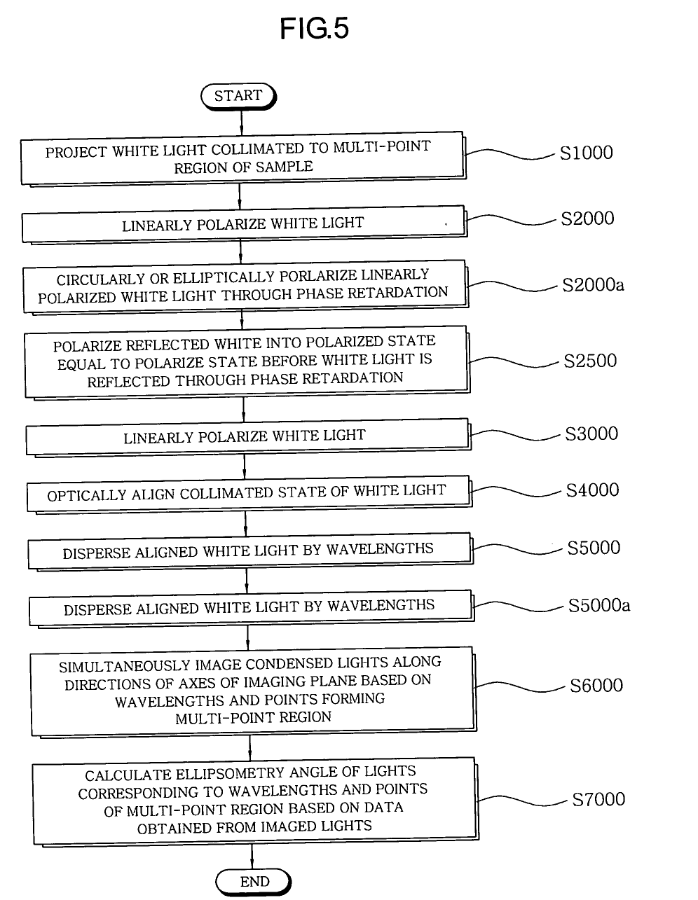

FIG. 5 is a flow chart showing an ellipsometry method using spectral imaging according to the present invention. Referring to FIG. 5, the ellipsometry method according to the invention collimates the white light to the multi-point region of the sample 2000, which is an object to be measured, projects the white light to the multi-point region, reflects the white light from the multi-point region, and disperses the reflected white light by wavelengths to simultaneously obtain information about the physical property of the multi-point region by wavelengths and by the points of the multi-point region.

Specifically, the multi-point region is defined on the surface of the sample 2000, and the white light is collimated to the multi-point region and projected thereto in step 1000. The projected white light is linearly polarized in step 2000.

Since it is known that the effectiveness of measurement is improved when the white light is circularly or elliptically polarized depending on the type of the sample, the white light can be circularly or elliptically polarized using the retarder in step 2000a. When the circularly or elliptically polarized white light is input to the multi-point region and reflected therefrom, the reflected white light is elliptically polarized and includes information about the position and physical property of each of the points forming the multi-point region.

Then, the white light is circularly or elliptically polarized through phase retardation in step S2500 such that the polarized state of the white light corresponds to the circularly or elliptically polarized state before the white light is reflected in step S2500a. Subsequently, the circularly or elliptically polarized white light is linearly polarized such that the white light is easily analyzed in step S3000.

Here, the initial collimated state of the white light may be changed while the white light is reflected from the multi-point region. Thus, the collimated state of the white light should be initialized. Accordingly, the entrance slit 310 whose shape corresponds to the initial collimated state is prepared, and the linearly polarized white light passes through the entrance slit 310 to be optically aligned in step S4000.

The aligned white light having information about the physical property of the points of the multi-point region is dispersed by wavelengths in step S5000. The dispersed lights are imaged by wavelengths and thus a large amount of optical data can be obtained.

The condensing lens 330 condenses the lights dispersed by wavelengths on the imaging plane in step S5000a. Here, the CCD solid-state imaging device 340 is used for imaging the lights. The dispersed lights are simultaneously imaged on the imaging plane of the CCD slid-state imaging device 340 along the directions of the X- and Y-axes of the imaging plane based on the wavelengths of the dispersed lights and the points forming the multi-point region in step S6000.

Based on data obtained from the imaged lights, ellipsometry angle data of each of the lights, which corresponds to the wavelength of each of the lights and each of the points of the multi-point region, is calculated in step S7000. Here, the ellipsometry angle data is basic data for obtaining property data of the multi-point region. A plurality of ellipsometry angles with respect to a specific point can be obtained by wavelengths and the obtained ellipsometry angles can be averaged. Thus, more accurate property data can be acquired.

While the ellipsometry system and method using spectral imaging use the light source module with which the collimating structure is integrally formed, a light source and a collimating structure, which are separated from each other, can be also used.

Furthermore, the ellipsometer of the present invention can employ a structure for supporting the sample 2000 and a driver for moving the supporting structure, for example, a linear motor. The driver and the supporting structure are used for moving the sample such that the collimated white light is projected to the predetermined multi-point region.

As described above, the ellipsometry system and method using spectral imaging according to the present invention can obtain information about the physical property of the multi-point region at a time. This remarkably reduces a period of time required for measurement and thus measurement can be rapidly carried out.

Moreover, since the white light having information about the physical property of a point is dispersed by wavelengths, a large amount of data about the point can be obtained to improve reliability of measurement.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. An ellipsometer system using spectral imaging, comprising:
a light source group including a light source module for collimating/projecting a white light to a multi-point region located in one direction on the surface of a sample, and a polarizer located on a path of the projected light to linearly polarize the white light;
a light analysis group including an analyzer, arranged optically opposite to the light source group, for linearly polarizing the white light that is reflected from the multi-point region of the sample and elliptically polarized and has information about position and physical property of the multi-point region;
a spectral imaging group located on the same optical axis as that of the light analysis group, the spectral imaging group including light dispersing means for dispersing the white light by wavelengths, and light detection means for simultaneously imaging the dispersed lights on an imaging plane in the directions of axes of the imaging plane based on the wavelengths of the dispersed lights and respective points forming the multi-point region; and
a computer electrically connected to the light detection means for calculating an ellipsometry angle of each of the lights, which corresponds to the wavelength of the light and each of the points forming the multi-point region, based on data transmitted from the light detection means.

2. The ellipsometer system as claimed in claim 1, wherein the light source module included in the light source group is constructed in such a manner that a light source and a collimating structure are integrally formed with each other.

3. The ellipsometer system as claimed in claim 1, wherein the light source group further includes a first phase retarder that is located behind the polarizer on the same optical axis as that of the polarizer and circularly or elliptically polarizes the linearly polarized white light.

4. The ellipsometer system as claimed in claim 3, wherein the light analysis group further includes a second phase retarder located in front of the analyzer on the same optical axis as that of the analyzer to polarize the elliptically polarized white light, the second phase retarder optically corresponding to the first phase retarder.

5. The ellipsometer system as claimed in claim 1, wherein the light detection meanas is a CCD solid-state imaging device.

6. The ellipsometer system as claimed in claim 5, wherein the spectral imaging group further includes a condensing lens located between the light dispersing means and the CCD solid-state imaging device for condensing the dispersed lights on the imaging plane of the CCD solid-state imaging device.

7. The ellipsometer system as claimed in claim 1, wherein the spectral imaging group further includes an entrance slit located in front of the light dispersing means on the same optical axis as that of the light dispersing means to optically align the collimated state of the white light, the shape of the entrance slit corresponding to the initial collimated shape of the white light.

8. An ellipsometry method using spectral imaging, comprising the steps of:
projecting a white light collimated to a multi-point region located in one direction on the surface of a sample;
linearly polarizing the white light;
linearly polarizing a white light reflected from the multi-point region of the sample and elliptically polarized, the white light having information about the position and physical property of the multi-point region;
optically aligning the collimated state of the white light;
dispersing the aligned white light by wavelengths;
simultaneously imaging the dispersed lights on an imaging plane along the directions of axes of the imaging plane based on corresponding wavelengths of the lights and points forming the multi-point region; and
calculating an ellipsometry angle of each of the lights, which corresponds to the wavelength of the light and each of the points forming the multi-point region, based on data obtained from the imaged lights.

9. The ellipsometry method as claimed in claim 8, further comprising a step of circularly or elliptically polarizing the linearly polarized white light through phase retardation after the step of linearly polarizing the white light.

10. The ellipsometry method as claimed in claim 9, further comprising a step of polarizing the white light such that the polarized state of the white light optically corresponds to the polarized state before the white light is reflected, before the step of linearly polarizing the reflected white light

11. The ellipsometry method as claimed in claim 8, wherein, in the step of imaging the dispersed lights, the dispersed lights are imaged on a CCD solid-state imaging device arranged on the optical paths of the dispersed lights.

12. The ellipsometry method as claimed in claim 11, further comprising a step of condensing the dispersed lights on the imaging plane of the CCD solid-state imaging device after the step of dispersing the white light.

13. The ellipsometry method as claimed in claim 12, wherein, in the condensing step, the dispersed lights are condensed by a condensing lens that is arranged in front of the CCD solid-state imaging device on the optical paths of the dispersed lights.

14. The ellipsometry method as claimed in claim 8, wherein, in the step of aligning the collimated sate of the white light, the collimated state of the white light is aligned using an entrance slit whose shape corresponds to the initial collimated shape of the white light.
